(19) United States
(12) Patent Application Publication
(10) Pub. No.: US 2013/0322533 A1
(43) Pub. Date: Dec. 5, 2013

(54) ENCODING DEVICE

(71) Applicants: Motoaki Yasui, Osaka-shi (JP); Akira Okamoto, Osaka-shi (JP)

(72) Inventors: Motoaki Yasui, Osaka-shi (JP); Akira Okamoto, Osaka-shi (JP)

(73) Assignee: MEGACHIPS CORPORATION, Osaka-shi (JP)

(21) Appl. No.: 14/000,344

(22) PCT Filed: Feb. 21, 2012
(86) PCT No.: PCT/JP12/54170

§ 371 Date: Aug. 19, 2013

(30) Foreign Application Priority Data
Feb. 28, 2011 (JP) 2011-041270

(51) Int. Cl. H04N 7/32

(52) U.S. Cl. CPC H04N 19/00569
USPC 375/240.12

(57) ABSTRACT

A coding device that achieves reduction in a circuit size and in the number of processing cycles is obtained. A coding device includes a first arithmetic unit that calculates a first difference value between an input image and a predicted image with respect to each of blocks having a first block size included in a macroblock to be coded, and a second arithmetic unit that calculates a second difference value between an input image and a predicted image for each of blocks having a second block size larger than the first block size included in the macroblock, and a prediction mode determination unit that determines a prediction mode to be applied to the macroblock, based on the first difference values of the macroblock calculated by the first arithmetic unit and the second difference values of the macroblock calculated by the second arithmetic unit.

### TECHNICAL FIELD

The present invention relates to coding devices, and more particularly, to a coding device that performs intra-frame predictive coding on image data of a moving image.

### BACKGROUND ART

Patent Literature 1 cited below, for example, discloses a technique for calculating a predicted amount of code to be generated, based on a difference value (SAD or SATD) between an input image and a predicted image.

Patent Literature 2 cited below, for example, discloses a technique for detecting an edge in an input image with a filter circuit and changing prediction modes based on a result of detection.

### CITATION LIST

### Patent Literature

[Patent Literature 1] JP2008-124699A
[Patent Literature 2] JP2008-219205A

### SUMMARY OF THE INVENTION

### Problems to be Solved by the Invention

Combining the techniques disclosed in the above Patent Literatures 1 and 2, to realize calculation of a predicted amount of code to be generated and detection of an edge in one and the same device, requires individual implementation of a circuit to calculate a predicted amount of code to be generated and a circuit to detect an edge, causing an increase in the circuit size and in the number of processing cycles.

Moreover, according to the technique disclosed in the above Patent Literature 2, edge detection is performed not on a difference image to be coded directly, but on an input image. This may result in an inadequate change of prediction modes, since an edge detected in the input image may not appear in the difference image, or an edge not detected in the input image may appear in the difference image.

The present invention has been made in view of such situation, and is directed to obtaining a coding device with a reduced circuit size and a reduced number of processing cycles, compared to one with a circuit to calculate a predicted amount of code to be generated and a circuit to detect an edge being implemented individually. The present invention is also directed to obtaining a coding device that achieves more adequate change of prediction modes, compared to one that changes prediction modes based on a result of edge detection performed on an input image.

### Means to Solve the Problems

A coding device according to a first aspect of the present invention includes a first calculation unit that calculates a first difference value between an input image and a predicted image with respect to each of blocks having a first block size included in a macroblock to be coded, a second calculation unit that calculates a second difference value between an input image and a predicted image with respect to each of blocks having a second block size larger than the first block size included in the macroblock, and a determination unit that determines a prediction mode to be applied to the macroblock, based on the first difference values of the macroblock calculate by the first calculation unit and the second difference values of the macroblock calculated by the second calculation unit.

According to the coding device of the first aspect, the determination unit determines a prediction mode to be applied to a macroblock, based on first difference values calculated by the first calculation unit and second difference values calculated by the second calculation unit. A difference value between an input image and a predicted image is an index for calculating a predicted amount of code to be generated. Thus using the difference value not only for calculating a predicted amount of code to be generated but also for determining a prediction mode achieves reduction in a circuit size and in the number of processing cycles.

A coding device according to a second aspect of the present invention is the coding device according to the first aspect, wherein the determination unit judges presence or absence of an edge in the macroblock based on a total sum of the first difference values and a total sum of the second difference values, and if an edge is judged to be present, determines to apply to the macroblock a first prediction mode in which prediction is performed by a block unit of the first block size, while if an edge is judged to be absent, determines to apply to the macroblock a second prediction mode in which prediction is performed by a block unit of the second block size.

According to the coding device of the second aspect, the determination unit judges presence or absence of an edge based on a difference value between an input image and a predicted image. Thus in comparison with a device with a circuit for calculating a predicted amount of code to be generated and a circuit for detecting an edge being implemented separately, a circuit size and the number of processing cycles are reduced.

A coding device according a third aspect of the present invention is the coding device according to the second aspect, wherein the determination unit judges that an edge is present in the macroblock if a value obtained by reducing a total sum of the first difference values from a total sum of the second difference values is larger than a first threshold.

In the coding device according to the third aspect, the determination unit judges that an edge is present in the macroblock if a value obtained by reducing a total sum of the first difference values from a total sum of the second difference values is larger than a first threshold. In the presence of an edge in a macroblock, a first difference value calculated by using a block having a small block size tends to be significantly smaller than a second difference value calculated by using a block having a large block size. Thus judging that an edge is present if a value obtained by reducing a total sum of the first difference values from a total sum of the second difference values is larger than the first threshold achieves highly accurate judgment as to presence or absence of an edge.

A coding device according to a fourth aspect of the present invention is the coding device according to the third aspect, wherein the first threshold is set at a different value depending on image complexity or a target amount of code.

In the coding device according to the fourth aspect, the first threshold is set at a different value depending on image complexity or a target amount of code. Since applying the first prediction mode to an image with high complexity is likely to greatly increase a generated amount of code, the first threshold of such an image can be set at a large value, so that the second prediction mode is more likely to be selected. In contrast, since applying the first prediction mode to an image with low complexity is likely to less greatly increase a generated amount of code, the first threshold can be set at a small value, so that the first prediction mode is more likely to be select. Moreover, since applying the first prediction mode is likely to increase a generated amount of code, the first threshold in a case of a small target amount of code can be set at a large value, so that the second prediction mode is more likely to be selected. In contrast, since applying the first prediction mode improves an image quality, the first threshold in a case of a large target amount of code can be set at a small value, so that the first prediction mode is more likely to be selected.

A coding device according to a fifth aspect of the present invention is the coding device according to the third or the fourth aspect, wherein the determination unit further judges that an edge is present in the macroblock if a total sum of the first difference values is smaller than the second threshold.

In the coding device according to the fifth aspect, the determination unit judges that an edge is present in the macroblock if a total sum of the first difference values is smaller than the second threshold. Since the first difference values and the second difference values of an image with high complexity both become large even in the absence of an edge in the macroblock, a value obtained by reducing a total sum of the first difference values from a total sum of the second difference values tends to be large. Thus if a total sum of the first difference values is equal to or larger than the second threshold, the macroblock can be merely regarded as an area of an image with high complexity and excluded from judgment as to presence or absence of an edge, so as to avoid an erroneous judgment that an edge is present.

A coding device according to a sixth aspect of the present invention is the coding device according to the fifth aspect, wherein the second threshold is set at a different value depending on image complexity or a target amount of code.

In the coding device according to the sixth aspect, the second threshold is set at a different value depending on image complexity or a target amount of code. Since applying the first prediction mode to an image with high complexity is likely to greatly increase a generated amount of code, the second threshold of such an image can be set at a small value, so that the second prediction mode is more likely to be selected. In contrast, since applying the first prediction mode to an image with low complexity is likely to less greatly increase a generated amount of code, the second threshold can be set at a large value, so that the first prediction mode is more likely to be selected. Moreover, since applying the first prediction mode is likely to increase a generated amount of code, the second threshold in a case of a small target amount of code can be set at a small value, so that the second prediction mode is more likely to be selected. In contrast, since applying the first prediction mode improves an image quality, the second threshold in a case of a large target amount of code can be set at a large value, so that the first prediction mode is more likely to be selected.

A coding device according to a seventh aspect of the present invention is the coding device according to any one of the first to the sixth aspects, wherein the first and the second difference value is a Sum of Absolute Transformed Differences (SATD).

In the coding device according to the seventh aspect, the first and the second difference value is an SATD. Since frequency components are significantly different between an edge and the rest, employing the SATD that includes a frequency component achieves more accurate judgment as to presence or absence of an edge, than employing a Sum of Absolute Differences (SAD) that does not include a frequency component.

A coding device according to an eighth aspect of the present invention includes an image production unit that produces a difference image between an input image and a predicted image of a macroblock to be coded, and a determination unit that determines a prediction mode to be applied to the macroblock based on presence or absence of an edge in the difference image produced by the image production unit.

In the coding device according to the eighth aspect, the image production unit produces a difference image between an input image and a predicted image, and the determination unit determines a prediction mode to be applied to a macroblock based on presence or absence of an edge in the difference image produced by the image production unit. Judging presence or absence of an edge in the difference image to be coded directly, rather than that in the input image, achieves more adequate change of a prediction mode than change of a prediction mode based on edge detection performed on the input image.

### Effects of the Invention

The present invention achieves reduction in a circuit size and in the number of processing cycles, and also achieves more adequate change of a prediction mode.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a block diagram illustrating a simplified, overall configuration of a coding device according to an embodiment of the present invention.

FIG. 2 is a block diagram illustrating a configuration of an intra prediction processor.

FIG. 3 is a diagram illustrating one macroblock divided into 16 blocks having a block size of 4 pixels in column×4 pixels in row.

FIG. 4 is a diagram illustrating one macroblock divided into four blocks having a block size of 8 pixels in column×8 pixels in row.

### DESCRIPTION OF THE INVENTION

Preferred embodiments of the present invention are described in detail below referring to the drawings. It should be noted that identical reference numerals throughout the drawings indicate identical or equivalent elements.

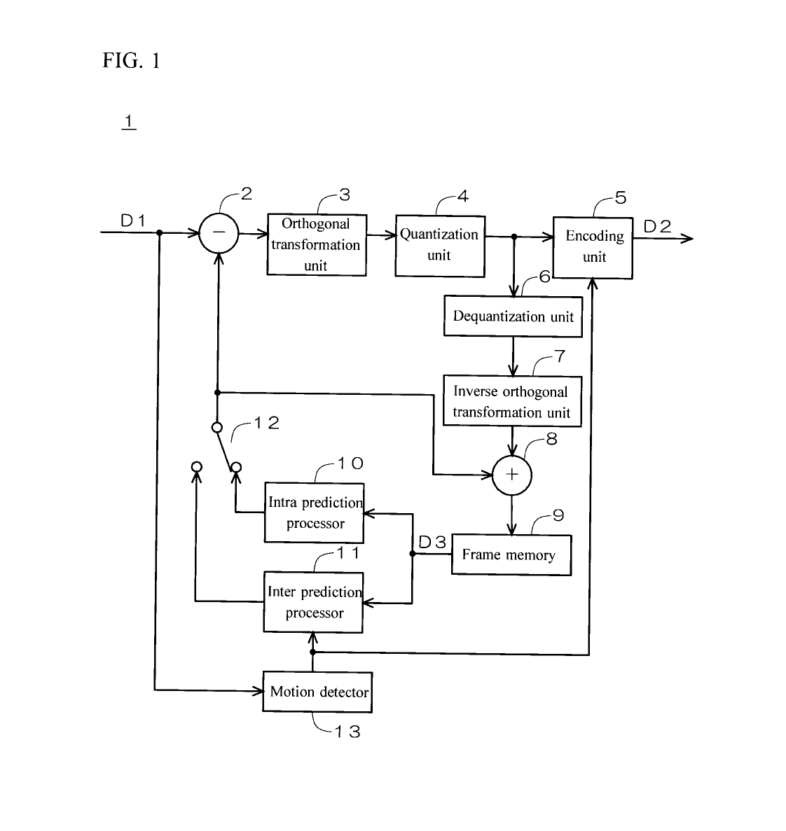

FIG. 1 is a block diagram illustrating a simplified, overall configuration of a coding device 1 according to an embodiment of the present invention. As illustrated in relation of connection in FIG. 1, the coding device 1 includes a subtracter 2, an orthogonal transformation unit 3, a quantization unit 4, an encoding unit 5, a dequantization unit 6, an inverse orthogonal transformation unit 7, an adder 8, a frame memory 9, an intra prediction processor 10, an inter prediction processor 11, a switch 12, and a motion detector 13. The coding device 1 receives an input of data D1 of an input image. The coding device 1 outputs coded data D2. The intra prediction processor 10 and the inter prediction processor 11 receives an input of data D3 of a local decoded image from the frame memory 9.

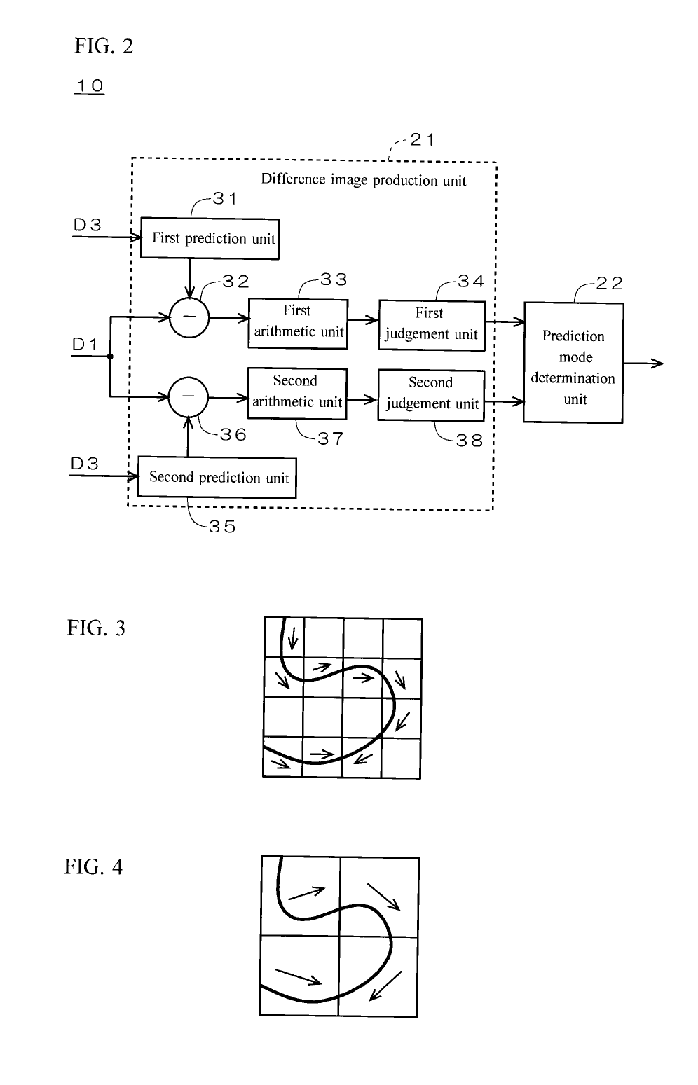

FIG. 2 is a block diagram illustrating a configuration of the intra prediction processor 10. The intra prediction processor 10 includes a difference image production unit 21 and a prediction mode determination unit 22. As illustrated in relation of connection in FIG. 2, the difference image production unit 21 includes a first prediction unit 31, a subtracter 32, a first arithmetic unit 33, a first judgment unit 34, a second prediction unit 35, a subtracter 36, a second arithmetic unit 37, and a second judgment unit 38.

H.264 defines three intra prediction modes including an intra 4×4 prediction mode (hereinafter, “first prediction mode”), an intra 8×8 prediction mode (hereinafter, “second prediction mode), and an intra 16×16 prediction mode (hereinafter, “third prediction mode”). In the first prediction mode, prediction and orthogonal transformation are performed by a block unit of 4 pixels in column×4 pixels in row. In the second prediction mode, prediction and orthogonal transformation are performed by a block unit of 8 pixels in column×8 pixels in row. In the third prediction mode, prediction is performed by a macroblock unit of 16 pixels in column×16 pixels in row, and orthogonal transformation is performed by a block unit of 4 pixels in column×4 pixels in row.

Furthermore, H.264 defines nine prediction directions for each of the first and the second prediction mode, and four prediction directions for the third prediction mode. The coding device 1 according to the present embodiment does not employ the third prediction mode but employs either the first or the second prediction mode to be applied to macroblocks to be coded. The prediction mode is set by a macroblock unit. Referring to FIG. 2, the first prediction unit 31, the subtracter 32, the first arithmetic unit 33, and the first judgment unit 34 correspond to the first prediction mode, while the second prediction unit 35, the subtracter 36, the second arithmetic unit 37 and the second judgment unit 38 correspond to the second prediction mode.

FIG. 3 is a diagram illustrating one macroblock divided into 16 blocks having a block size of 4 pixels in column×4 pixels in row. FIG. 4 is a diagram illustrating one macroblock divided into four blocks having a block size of 8 pixels in column×8 pixels in row. The thick line in the figure represents an edge in the macroblock, and the arrows in the figure represent an optimal prediction direction for each block.

Referring to FIG. 2, the first prediction unit 31 produces predicted images in nine directions for each of the 16 blocks included in a macroblock to be coded. The subtracter 32 produces difference images between the input image and the predicted images in nine directions for each of the 16 blocks. Thus nine difference images are obtained for each block. The difference images are inputted to the first arithmetic unit 33. The first arithmetic unit 33 calculates a Sum of Absolute Transformed Differences (SATD) for each difference image based on the following Expression (1). Thus nine SATDs are obtained for each block.

$$[ Expression 1 ]$$

$$S A T D = {\sum }_{1}^{16} \vert A D M ( Org - Pred ) \vert \\ Org \text{:} Luminance of each pixel in input image \\ Pred \text{:} Luminance of each pixel in predicated image \\ A D M \text{:} Hadamard transform \qquad ( 1 )$$

As Expression (1) shows, the SATD is obtained by performing an Hadamard transform on the difference images and calculating a sum of absolute difference of the coefficients. It should be noted that the difference value between the input image and the predicted image may be a Sum of Absolute Differences (SAD) or the like, instead of an SATD.

The SATDs are inputted to the first judgment unit 34. The first judgment unit 34 calculates a predicted amount of code to be generated from each SATD, based on the following Expression (2).

[Expression 2]

COST=SATD+λ (2)
COST: Predicted amount of code to be generated
λ: Offset value

The offset value λ, which is a value dependent on a quantization parameter, corresponds to a code amount other than a pixel code amount (for example, prediction direction code amount). Thus the predicted amount of code to be generated is obtained for each of the nine directions of each block.

Next, the first judgment unit 34 selects the smallest predicted amount of code to be generated from the nine predicted amounts of code to be generated of each block, and identifies the prediction direction corresponding to the smallest amount of code to be generated as the optimal prediction direction of the block. The first judgment unit 34 performs the same processes on the 16 blocks in the macroblock, so as to input the optimal prediction directions and the corresponding SATD of each block to the prediction mode determination unit 22.

Similar to the above, the second prediction unit 35 produces predicted images in nine directions for each of the four blocks included in the macroblock to be coded. The subtracter 36 produces difference images between the input image and the predicted images in nine directions for each of the four blocks. Thus nine difference images are obtained for each block. The difference images are inputted to the second arithmetic unit 37. The second arithmetic unit 37 calculates an SATD for each difference image based on the following Expression (3). Thus nine SATDs are obtained for each block.

$$\begin{matrix}[ Expression 3 ] & \\ S A T D = {\sum }_{1}^{64} \vert A D M ( Org - Pred ) \vert & ( 3 )\end{matrix}$$

The SATDs are inputted to the second judgment unit 38. The second judgment unit 38 calculates a predicted amount of code to be generated from each SATD, based on the above Expression (2). Thus the predicted amount of code to be generated is obtained for each of the nine directions of each block.

Next, the second judgment unit 38 selects the smallest predicted amount of code to be generated from the nine predicted amount of code to be generated of each block, and identifies the prediction direction corresponding to the smallest amount of code to be generated as the optimal prediction direction of the block. The second judgment unit 38 performs the same processes on the four blocks in the macroblock, so as to input the optimal prediction direction and the corresponding SATDs of each block to the prediction mode determination unit 22.

The prediction mode determination unit 22 determines a prediction mode (first or second prediction mode) to be applied to the macroblock to be coded, based on the 16 pairs of optimal prediction directions and SATDs inputted from the first judgment unit 34 and the four pairs of optimal prediction directions and SATDs inputted from the second judgment unit 38. The details are as follows.

The prediction mode determination unit 22 calculates a total sum MB_SATD₁ of the 16 SATDs inputted from the first judgment unit 34, based on the following Expression (4).

$$\begin{matrix}[ Expression 4 ] & \\ {MB\_SATD}_{1} = {{\sum }^{16}}_{1} S A T D & ( 4 )\end{matrix}$$

The prediction mode determination unit 22 also calculates a total sum MB_SATD₂ of the four SATDs inputted from the second judgment unit 38, based on the following Expression (5).

$$\begin{matrix}[ Expression 5 ] & \\ {MB\_SATD}_{2} = {{\sum }_{1}}^{4} S A T D & ( 5 )\end{matrix}$$

The summation numbers of addition of Expressions (4) and (5) are 16 and four, respectively, and thus these operations can be implemented with a relatively small circuit.

Next, the prediction mode determination unit 22 judges presence or absence of an edge in the macroblock, based on the following Expressions (6) and (7).

[Expression 6]

(MB_SATD₂−MB_SATD₁)>TH_EDGE (6)
TH_EDGE: First threshold

[Expression 7]

MB_SATD₁<TH_FINE (7)
TH_FINE: Second threshold

If both of the Expressions (6) and (7) are met, the prediction mode determination unit 22 judges that an edge is present in the macroblock to be coded. In contrast, if at least one of the Expressions (6) and (7) is not met, the prediction mode determination unit 22 judges that an edge is absent in the macroblock to be coded. It should be noted that the first threshold TH_EDGE and the second threshold TH_FINE are set at an adequate value in accordance with an experiment, simulation, or the like.

It should also be noted that the prediction mode determination unit 22 may judge presence or absence of an edge based on the following Expressions (8) and (9), instead of the above Expressions (6) and (7).

$$\begin{matrix}[ Expression 8 ] & \\ \frac{{MB\_SATD}_{2} + α}{{MB\_SATD}_{1} + β} > TH\_EDGE \\ α , β \text{:} Offset value & ( 8 ) \\ [ Expression 9 ] & \\ {MB\_SATD}_{1} > TH\_FLAT \\ TH\_FLAT \text{:} Third threshold & ( 9 )\end{matrix}$$

If both of the Expressions (8) and (9) are met, the prediction mode determination unit 22 judges that an edge is present in the macroblock to be coded. In contrast, if at least one of the Expressions (8) and (9) is not met, the prediction mode determination unit 22 judges that an edge is absent in the macroblock to be coded. It should be noted that the offset values α and β and the third threshold TH_FLAT are set at an adequate value in accordance with an experiment, simulation, or the like.

Next, if an edge is judged to be present, the prediction mode determination unit 22 determines to apply the first prediction mode to the macroblock to be coded, while if an edge is judged to be absent, it determines to apply the second prediction mode to the macroblock to be coded. Then the prediction mode determination unit 22 outputs the determined prediction mode and the optimal prediction direction for each block.

Regarding the above Expressions (6) and (7), the first threshold TH_EDGE and the second threshold TH_FINE may be set at different values, depending on image complexity, a target amount of code, or the like. Since applying the first prediction mode to an image with high complexity is likely to greatly increase a generated amount of code, the first threshold TH_EDGE of such an image can be set at a large value, so that the second prediction mode is more likely to be selected. In contrast, since applying the first prediction mode to an image with low complexity is likely to less greatly increase a generated amount of code, the first threshold TH_EDGE of such an image can be set at a small value, so that the first prediction mode is more likely to be selected. Moreover, since applying the first prediction mode is likely to increase a generated amount of code, the first threshold TH_EDGE in a case of a small target amount of code can be set at a large value, so that the second prediction mode is more likely to be selected. In contrast, since applying the first prediction mode improves an image quality, the first threshold TH_EDGE in a case of a large target amount of code can be set at a small value, so that the first prediction mode is more likely to be selected.

According to the coding device 1 of the present embodiment as described above, the prediction mode determination unit 22 determines a prediction mode to be applied to a macroblock, based on multiple difference values calculated by the first arithmetic unit 33 and multiple difference values calculated by the second arithmetic unit 37. A difference value between an input image and a predicted image is an index for calculating a predicted amount of code to be generated. Thus using the difference value not only for calculating a predicted amount of code to be generated but also for determining a prediction mode achieves reduction in a circuit size and in the number of processing cycles.

Also according to the coding device 1 of the present embodiment, the prediction mode determination unit 22 judges presence or absence of an edge, based on a difference value between an input image and a predicted image. Thus in comparison with a device with a circuit for calculating a predicted amount of code to be generated and a circuit for detecting an edge being implemented separately, a circuit size and the number of processing cycles are reduced.

Also according to the coding device 1 of the present embodiment, the prediction mode determination unit 22 judges that an edge is present in a macroblock if a value obtained by reducing MB_SATD₁ from MB_SATD₂ is larger than the first threshold TH_EDGE, as in Expression (6). In the presence of an edge in a macroblock, a difference value calculated by using a block having a small block size (4 pixels in column×4 pixels in row) tends to be significantly smaller than a difference value calculated by using a block having a large block size (8 pixels in column×8 pixels in row). This is because, as illustrated in FIGS. 3 and 4, using a block having a small block size (FIG. 3) allows an optimal prediction direction to be set with a smaller block size unit, than using a block having a large block size (FIG. 4). Thus judging that an edge is present if a condition in Expression (6) is met achieves highly accurate judgment as to presence or absence of an edge.

Also according to the coding device 1 of the present embodiment, the prediction mode determination unit 22 judges that an edge is present in a macroblock if MB_SATD₁ is smaller than the second threshold TH_FINE, as in Expression (7). Since a difference value of an image with high complexity becomes large even in the absence of an edge in the macroblock, a value obtained by reducing MB_SATD₁ from MB_SATD₂ tends to be large. Thus if the MB_SATD₁ is equal to or larger than the second threshold TH_FINE, the macroblock can be merely regarded as an area of an image with high complexity and excluded from judgment as to presence or absence of an edge, so as to avoid an erroneous judgment that an edge is present.

Also according to the coding device 1 of the present embodiment, the difference value is an SATD. Since frequency components are significantly different between an edge and the rest, employing the SATD that includes a frequency component achieves more accurate judgment as to presence or absence of an edge, than employing an SAD that does not include a frequency component.

Also according to the coding device 1 of the present embodiment, the difference image production unit 21 produces an difference image between an input image and a predicted image, and the prediction mode determination unit 22 determines a prediction mode to be applied to a macroblock, based on presence or absence of an edge in the difference image produced by the difference image production unit 21. Judging presence or absence of an edge in the difference image to be coded directly, rather than that in the input image, achieves more adequate change of a prediction mode than change of a prediction mode based on edge detection performed on the input image.

While the invention has been described in detail, the foregoing description is in all aspects illustrative and not restrictive. It is therefore understood that numerous modifications and variations can be devised without departing from the scope.

### EXPLANATION OF REFERENCE NUMERALS

1 coding device
10 intra prediction processor
21 difference image production unit
22 prediction mode determination unit
31 first prediction unit
33 first arithmetic unit
34 first judgment unit
35 second prediction unit
37 second arithmetic unit
38 second judgment unit

1. A coding device comprising:
a first calculation unit configured to calculate a first difference value between an input image and a predicted image with respect to each of a plurality of blocks having a first block size included in a macroblock to be coded;
a second calculation unit configured to calculate a second difference value between an input image and a predicted image with respect to each of a plurality of blocks having a second block size larger than the first block size included in the macroblock; and
a determination unit configured to determine a prediction mode to be applied to the macroblock, based on a plurality of the first difference values of the macroblock calculated by the first calculation unit and a plurality of the second difference values of the macroblock calculated by the second calculation unit.

2. The coding device according to claim 1, wherein
the determination unit judges presence or absence of an edge in the macroblock based on a total sum of the plurality of the first difference values and a total sum of the plurality of the second difference values, and if an edge is judged to be present, the determination unit determines to apply to the macroblock a first prediction mode in which prediction is performed by a block unit of the first block size, while if an edge is judged to be absent, the determination unit determines to apply to the macroblock a second prediction mode in which prediction is performed by a block unit of the second block size.

3. The coding device according to claim 2, wherein
the determination unit judges that an edge is present in the macroblock if a value obtained by reducing a total sum of the plurality of the first difference values from a total sum of the plurality of the second difference values is larger than a first threshold.

4. The coding device according to claim 3, wherein
the first threshold is set at a different value depending on image complexity or a target amount of code.

5. The coding device according to claim 3, wherein
the determination unit further judges that an edge is present in the macroblock if a total sum of the plurality of the first difference values is smaller than the second threshold.

6. The coding device according to claim 5, wherein
the second threshold is set at a different value depending on image complexity or a target amount of code.

7. The coding device according to claim 1, wherein
the first difference value and the second difference value are a Sum of Absolute Transformed Differences (SATD).

8. A coding device comprising:
an image production unit configured to produce a difference image between an input image and a predicted image of a macroblock to be coded; and
a determination unit configured to determine a prediction mode to be applied to the macroblock, based on presence or absence of an edge in the difference image produced by the image production unit.
